(19) United States
(12) Patent Application Publication
(10) Pub. No.: US 2014/0205548 A1
(43) Pub. Date: Jul. 24, 2014

(54) AEROSOL FOR CONTROLLING INDOOR INSECT PEST

(71) Applicant: SUMITOMO CHEMICAL COMPANY, LIMITED, Tokyo (JP)

(72) Inventors: Masahiro YAMADA, Takarazuka-shi (JP); Yoshito TANAKA, Takarazuka-shi (JP)

(73) Assignee: SUMITOMO CHEMICAL COMPANY, LIMITED, Tokyo (JP)

(21) Appl. No.: 14/157,659

(22) Filed: Jan. 17, 2014

(30) Foreign Application Priority Data
Jan. 18, 2013 (JP) 2013-007088

(51) Int. Cl. A01N 53/00

(52) U.S. Cl. CPC A01N 53/00
USPC 424/45

(57) ABSTRACT

The present invention relates to a direct hit type aerosol for controlling an insect pest exhibiting an excellent controlling effect on an insect pest, more specifically an aerosol for controlling an insect pest, comprising at least one pyrethroid compound, at least one organic solvent and at least one propellant, wherein the aerosol characteristic value calculated from the following formula is 0.5-25,

Formula): Aerosol characteristic value=Spray arrival distance (cm)×Spraying amount (g) per second/Weight concentration (%) of Pyrethroid compound;

and the pyrethroid compound is preferably represented by the formula (I):

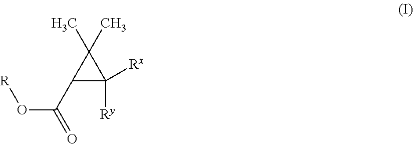

and more preferably at least one compound selected from the group consisting of imiprothrin, tetramethrin, prallethrin, transfluthrin, metofluthrin, dimefluthrin, 2,3,5,6-tetrafluoro-4-methylbenzyl 2,2-dimethyl-3-(1-propenyl)cyclopropanecarboxylate and the like.

### TECHNICAL FIELD

The present application is filed claiming the priority based on Japanese Patent Application No. 2013-007088 (filed on Jan. 18, 2013), the entire content of which is incorporated herein by reference.

The present invention relates to a direct hit type aerosol suitable for indoor use for controlling an insect pest comprising a pyrethroid compound as an active ingredient.

### BACKGROUND ART

Direct hit type aerosols for controlling an insect pest living indoors have been conventionally used and pyrethroid compounds have been practically used as an active ingredient contained in the aerosols due to their excellent knockdown effect on an insect pest. For example, Patent Literatures 1 to 3 describe compositions for an aerosol suitable for controlling an insect pest.

### CITATION LIST

### Patent Literature

Patent Literature 1: JP 2012-082192 A
Patent Literature 2: JP 2000-302612 A
Patent Literature 3: JP 1999-322502 A

### SUMMARY OF INVENTION

### Technical Problem

An object of the present invention is to provide a direct hit type aerosol for controlling an insect pest exhibiting an excellent controlling effect on an insect pest, comprising a pyrethroid compound with an excellent knockdown effect on an insect pest as an active ingredient.

### Solution to Problem

The present inventors intensively studied about various factors such as the shape of a bulb, the spraying amount and the concentration of an active ingredient to obtain a direct hit type aerosol which can enhance the excellent knockdown effect on an insect pest of a pyrethroid compound. As a result, it was found that a direct hit type aerosol with certain parameters exhibits an excellent effect in a small amount when used as an insect pest controlling agent comprising a pyrethroid compound as an active ingredient and thus the present invention was completed. Since the direct hit type aerosol of the present invention can control an insect pest efficiently, it does not often pollute indoor furniture, wall cloth and the like and thus is suitable for indoor use.

The present invention provides the followings:

[1] A direct hit type aerosol for controlling an insect pest, comprising at least one pyrethroid compound, at least one organic solvent and at least one propellant, wherein the aerosol characteristic value calculated from the following formula is 0.5-25,

Formula): Aerosol characteristic value=Spray arrival distance (cm)×Spraying amount (g) per second/Weight concentration (%) of Pyrethroid compound;

[2] The aerosol according to [1], wherein the pyrethroid compound is represented by the formula (I):

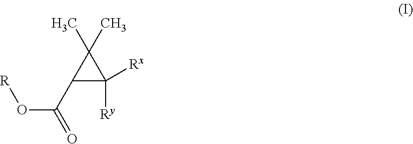

wherein
both R^{x} and R^{y} represent a methyl group; or
R^{x} represents a hydrogen atom and R^{y} represents a group of the following formula:

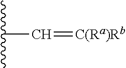

wherein
R^{a} represents a hydrogen atom, a halogen atom or a methyl group and R^{b} represents a halogen atom, a methyl group, a trifluoromethyl group or a cyano group; and
R represents a group selected from the following groups:

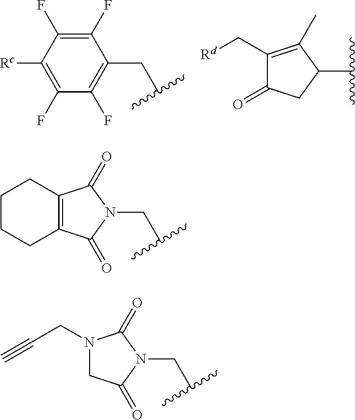

wherein
R^{c} represents a hydrogen atom, a methyl group, a propargyl group or a methoxymethyl group and R^{d} represents a vinyl group or an ethynyl group;
[3] The aerosol according to [1], wherein the pyrethroid compound is at least one compound selected from the group consisting of imiprothrin, tetramethrin, prallethrin, transfluthrin, metofluthrin, dimefluthrin, 2,3,5,6-tetrafluoro-4-(methoxymethyl)benzyl 2,2-dimethyl-3-[(1Z)-3,3,3-trifluoro-1-propenyl]cyclopropanecarboxylate, 2,3,5,6-tetrafluoro-4-methylbenzyl 2,2-dimethyl-3-(1-propenyl)cyclopropanecarboxylate, 2,3,5,6-tetrafluoro-4-(methoxymethyl)benzyl 2,2,3,3-tetramethylcyclopropanecarboxylate and 2,3,5,6-tetrafluoro-4-(methoxymethyl)benzyl 2,2-dimethyl-3-(2,2-dichlorovinyl)cyclopropanecarboxylate;
[4] The aerosol according to any one of [1] to [3], wherein the weight concentration of the pyrethroid compound is 2.0 to 10 wt %;
[5] The aerosol according to any one of [1] to [4], wherein the spraying amount per second is 0.1 to 0.4 g;
[6] The aerosol according to any one of [1] to [5], wherein the spray arrival distance is 70 to 120 cm.
[7] The aerosol according to any one of [1] to [6], wherein the organic solvent contains a saturated hydrocarbon solvent in an amount of 50 wt % or more;
[8] The aerosol according to any one of [1] to [7], wherein the capacity of the can is 200 ml or less;
[9] A method for controlling an insect pest, which comprises spraying the aerosol according to any one of [1] to [8] to an insect pest flying in the indoor space or crawling on the floor or wall indoors.

### Effects of Invention

The direct hit type aerosol of the present invention can enhance the controlling effect on an insect pest. Therefore, the aerosol of the present invention can efficiently control an indoor insect pest in a small amount. Since the aerosol of the present invention can control an insect pest in a small amount, it does not often pollute the indoor furniture, the wall cloth and the like with the organic solvent contained in the aerosol and thus is suitable for indoor use.

### DESCRIPTION OF EMBODIMENTS

In the present invention, the “direct hit type aerosol” means an aerosol insecticide which is used for controlling a target insect pest (for example, a fly or a mosquito flying in the air or a cockroach crawling on the wall) by directly contacting the target with the mist which is sprayed from the aerosol and contains the active ingredient. The present aerosol is different from those for spreading an active ingredient the whole indoor space in which an insect pest must be controlled, or those for applying an active ingredient to the passageway or nidus of an insect pest.

The direct hit type aerosol of the present invention (hereinafter referred to as “present aerosol”) is used by spraying it to an insect pest flying or crawling within the reach of the mist sprayed from the present aerosol. The pyrethroid compound, the active ingredient of the present aerosol has such a potent knockdown effect on an insect pest that the insect pest gets unable to continue to fly or creep or to move quickly in a short time when directly hit by the mist containing the active ingredient.

In the present invention, the “pyrethroid compound” means a natural or synthetic pyrethroid compound. Pyrethroid compound are characterized in that they are ester compounds with a cyclopropanecarboxylic acid skeleton. The preferred pyrethroid compound in the present invention is represented by the following formula (I):

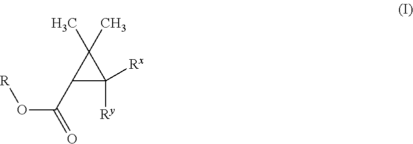

wherein
both R^{x} and R^{y} represent a methyl group; or
R^{x} represents a hydrogen atom and R^{y} represents a group of the following formula:

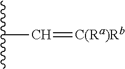

wherein
R^{a} represents a hydrogen atom, a halogen atom or a methyl group and R^{b} represents a halogen atom, a methyl group, a trifluoromethyl group or a cyano group; and
R represents a group selected from the following groups:

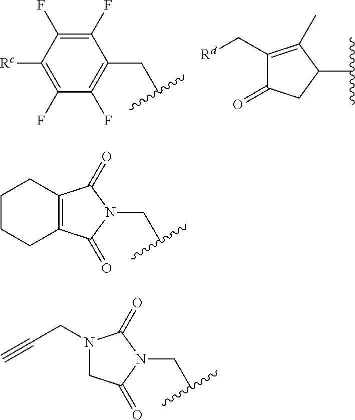

wherein
R^{c} represents a hydrogen atom, a methyl group, a propargyl group or a methoxymethyl group and R^{d} represents a vinyl group or an ethynyl group.

Specific examples of the pyrethroid compound in the present invention include acrinathrin, allethrin, beta-cyfluthrin, bifenthrin, cycloprothrin, cyfluthrin, cyhalothrin, cypermethrin, empenthrin, deltamethrin, fenpropathrin, fenvalerate, flucythrinate, flufenoprox, flumethrin, fluvalinate, halfenprox, imiprothrin, permethrin, prallethrin, pyrethrins, resmethrin, sigma-cypermethrin, silafluofen, tefluthrin, tralomethrin, transfluthrin, tetramethrin, phenothrin, cyphenothrin, alpha-cypermethrin, zeta-cypermethrin, lambda-cyhalothrin, gamma-cyhalothrin, furamethrin, tau-fluvalinate, metofluthrin, dimefluthrin, 2,3,5,6-tetrafluoro-4-(methoxymethyl)benzyl 2,2-dimethyl-3-[(1z)-3,3,3-trifuluoro-1-propenyl]cyclopropanecarboxylate, 2,3,5,6-tetrafluoro-4-methylbenzyl 2,2-dimethyl-3-(1-propenyl)cyclopropanecarobxylate, 2,3,5,6-tetrafluoro-4-(methoxymethyl)benzyl 2,2,3,3-tetramethylcyclopropanecarboxylate, 2,3,5,6-tetrafluoro-4-(methoxymethyl)benzyl 2,2-dimethyl-3-(2,2-dichlorovinyl)cyclopropanecarboxylate and 2,3,5,6-tetrafluoro-4-(2-propynyl)benzyl 2,2,3,3-tetramethylcyclopropanecarboxylate.

In the present invention, the pyrethroid compound is particularly preferably a compound with an excellent knockdown effect on an insect pest, specifically a compound selected from the group consisting of imiprothrin, tetramethrin, prallethrin, transfluthrin, methofluthrin, dimefluthrin, 2,3,5,6-tetrafluoro-4-(methoxymethyl)benzyl 2,2-dimethyl-3-[(1z)-3,3,3-trifluoro-1-propenyl]cyclopropanecarboxylate, 2,3,5,6-tetrafluoro-4-methylbenzyl 2,2-dimethyl-3-(1-propenyl)cyclopropanecarboxylate, 2,3,5,6-tetrafluoro-4-(methoxymethyl)benzyl 2,2,3,3-tetramethylcyclopropanecarboxylate, and 2,3,5,6-teterafluoro-4-(methoxymethyl)benzyl 2,2-dimethyl-3-(2,2-dichlorovinyl)cyclopropanecarboxylate.

The amount of the pyrethroid compound, the active ingredient contained in the present aerosol is generally 0.3 to 10 wt %, preferably 2.0 to 10 wt %, based on the total amount of the composition comprising the pyrethroid compound, an organic solvent and a propellant in an aerosol can (hereinafter referred to as “present aerosol composition”). In the present invention, the “weight concentration (%)” of the pyrethroid compound means a weight ratio of the pyrethroid compound contained in the present aerosol composition to the total weight of the composition.

The amount of the organic solvent is generally 10 to 70 wt % based on the total amount of the present aerosol composition.

The amount of the propellant is generally 20 to 80 wt % based on the total amount of the present aerosol composition.

The present aerosol may contain a formulation additive in an amount of 2 wt % or less, based on the total amount of the present composition, if necessary.

Examples of the formulation additive which may be contained in the present aerosol composition include synergists, viscosity modifiers, stabilizers and flavors.

The organic solvent to be used in the present aerosol is generally at least one organic solvent selected from the groups described below, and preferably an organic solvent containing a saturated hydrocarbon solvent selected from group (a) in an amount of 50 wt % or more;

Group (a): saturated hydrocarbon solvents normal paraffinic solvents such as Neo-chiozol (from Chuo 20. Kasei Co., Ltd), Norpar 13 (from ExxonMobil Yugen Kaisha), Norpar 15 (from ExxonMobil Yugen Kaisha); isoparaffinic solvents such as Isopar G (from ExxonMobil Yugen Kaisha), Isopar L (from ExxonMobil Yugen Kaisha), Isopar H (from ExxonMobil Yugen Kaisha) and Isopar M (from ExxonMobil Yugen Kaisha); linear saturated hydrocarbons such as Exxsol D40 (from ExxonMobil Yugen Kaisha), Exxsol D60 (from ExxonMobil Yugen Kaisha) and Exxsol D80 (from ExxonMobil Yugen Kaisha);
Group (b): ester solvents
alkyl alkylcarboxylates having 12 to 30 carbon atoms such as isopropyl myristate, hexyl laurate, and isopropyl palmitate; dialkyl dicarboxylates having 12 to 30 carbon atoms such as diisopropyl adipate, dioctyl adipate, diisononyl adipate, and diisodecyl adipate; trialkyl acetylcitrates having 12 to 30 carbon atoms such as triethyl acetylcitrate and tributyl acetylcitrate; and dialkyl phthalates having 12 to 30 carbon atoms such as dibutyl phthalate, and diisononyl phthalate;
Group (c): alcohol solvents
monoalcohol solvents such as ethanol, propanol, 2-propanol and butanol; glycol ether alcohol solvents such as ethylene glycol monomethyl ether, ethylene glycol monoethyl ether, ethylene glycol monopropylether, propylene glycol monomethyl ether, propylene glycol monoethyl ether, propylene glycol monopropylether;
Group (d): heterocyclic solvents
propylene carbonate, ethylene carbonate, sulfolane, γ-butyrolactone, N-methyl-2-pyrrolidone, N-ethyl-2-pyrrolidone, N-octyl-2-pyrrolidone and 1,3-dimethyl-2-imidazolidinone.

Examples of the propellant contained in the present aerosol include nitrogen gas, compressed air, carbon dioxide gas, liquefied petroleum gases (LPG), and dimethyl ether. The propellant contained in the present aerosol composition may be used alone or in combination of two or more. In the present invention, the propellant preferably includes liquefied petroleum gases.

The present aerosol comprises the present aerosol composition included in a pressure-proof container with a spraying device. The spraying device has at least an aerosol valve and an actuator, and can spray the content of the container in a certain direction by the pressure due to the change in state of the propellant from a liquid to a gas. The pressure-proof container is generally a can made of metal, but the material of the container is not limited thereto.

The aerosol valve is not particularly limited, but is generally a push down-type aerosol valve.

The present aerosol can be prepared, for example, by charging the present pyrethroid compound and the organic solvent, and, if necessary, formulation additive(s) into a pressure-proof container; attaching an aerosol valve to the container; filling the container with a propellant via a stem; shaking the container; and attaching an actuator to the container.

The present aerosol preferably has an actuator having mechanical break-up system. Examples of the actuator include those described in JP 2010-235174 A.

In the present invention, the “spray arrival distance” of the present aerosol means the distance (cm) from the actuator part of the aerosol to the arrival point of the mist sprayed from the adequately-filled present aerosol when the mist was sprayed for a second in a sealed space without airflow. In the present invention, “adequately-filled present aerosol” means an aerosol that person in the art thinks the adequate volume of the aerosol composition is contained in the aerosol can, and the adequate volume is generally about 60 to 80 v/v % base on the volume of the aerosol can. The distance can be measured, for example, by observing the state of the mist using a speed camera with a light source set properly. In the present invention, the spray arrival distance is determined to be the longest distance in which an oil-sensitive paper placed in the spraying direction cannot be colored due to the attachment of the organic solvent contained in the aerosol.

In the present invention, the “spraying amount (g) per second” of the present aerosol means the amount (g) of the mist when the mist was sprayed for a second from the adequately-filled present aerosol. The spraying amount can be calculated from the reduced amount of the present aerosol composition after spraying.

In the present invention, the “aerosol characteristic value” means the value calculated by applying the spray arrival distance (cm), the spraying amount (g) per second and the weight concentration (%) of the pyrethroid compound to the following formula:

Formula): Aerosol characteristic value=Spray arrival distance (cm)×Spraying amount (g) per second/Weight concentration of Pyrethroid compound (%).

It is possible to control the spray arrival distance and the spraying amount per second by selecting size of orifice diameter of stem, size of orifice diameter of actuator and kinds of actuator, appropriately.

The above aerosol characteristic value of the present aerosol is 0.5 to 25. If the aerosol characteristic value is less than 0.5 or more than 25, the pyrethroid compound, the active ingredient of the present aerosol, is often used ineffectively. Namely, in such cases, a large volume of aerosol must be sprayed to knock down an insect pest. It may result in that the furniture, the wall cloth, etc. are polluted by the organic solvent contained in the aerosol composition, which unfavorably requires wiping off the organic solvent after using the aerosol.

The present aerosol can control a target insect pest in a small volume, and thus can be applied to a small volume aerosol. Examples of the small volume aerosol include those of which the can volume is 200 ml or less.

The present aerosol is used for controlling an insect pest by spraying it directly to a target insect pest. The present aerosol is preferably used in indoor space, such as room interiors, living rooms, dining rooms, closets, wardrobes, chests such as Japanese chests, cupboards, toilets, bathrooms, storerooms, warehouses and car interiors.

Examples of the insect pest which can be controlled by the present aerosol include the following arthropods such as insects and mites:

Lepidoptera such as Tinea translucens and Tineola bisselliella;
Diptera, for example, Culex spp. such as Culex pipiens pallens, Culex tritaeniorhynchus and Culex quinquefasciatus; Aedes spp. such as Aedes aegypti and Aedes albopictus; Anophelinae such as Anopheles sinensis and Anopheles gambiae; Chironomidae; Muscidae such as Musca domestica, Muscina stabulans and Fannia canicularis; Calliphoridae; Sarcophagidae; Anthomyiidae such as Delia platura and Delia antiqua; Tephritidae; Drosophilidae; Psychodidae; Phoridae; Tabanidae; Simuliidae; Culicoides; and Ceratopogonidae;
Dictyoptera such as Blattella germanica, Periplaneta fuliginosa, Periplaneta americana, Periplaneta australasiae, Periplaneta brunnea, and Blatta orientalis;
Hymenoptera such as Formicidae; and Apocrita (such as Polistinae, for example, Polistes chinensis, Polistes riparius, Polistes jakahamae, Polistes rothneyi, Polistes nipponensis, Polistes snelleni, Polistes japonicus; Vespinae, for example, Vespa mandarinia, Vespa simillima, Vespa analis, Vespa crabro, Vespa ducalis, Vespula flaviceps, Vespula shidai, Dolichovespula media; Bethylidae; Xylocopa virginica, Cyphononyx dorsalis, Ammophila sabulosa, Eumenidae and the like).

### EXAMPLES

Hereinafter, the present invention is further described in detail with reference to Examples such as preparation examples and test examples, to which the present invention is not limited. The term “part(s)” used herein means part(s) by weight.

First, preparation examples of the present aerosol and the reference aerosol are described.

### Preparation Example 1

Into an aerosol container, 4.5 parts of transfluthrin and 55.5 parts of Neo-chiozol (normal paraffinic hydrocarbon manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol containing 100 parts of the aerosol composition for controlling an insect pest (hereinafter referred to as “present aerosol A”).

### Preparation Example 2

Into an aerosol container, 2.0 parts of transfluthrin and 58.0 parts of Neo-chiozol (normal paraffinic hydrocarbon manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol containing 100 parts of the aerosol composition for controlling an insect pest (hereinafter referred to as “present aerosol B”).

### Preparation Example 3

Into an aerosol container, 4.5 parts of tetramethrin and 55.5 parts of Neo-chiozol (normal paraffinic hydrocarbon manufactured by Chuo. Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol containing 100 parts of the aerosol composition for controlling an insect pest (hereinafter referred to as “present aerosol C”).

### Preparation Example 4

Into an aerosol container, 2.25 parts of prallethrin and 57.75 parts of Neo-chiozol (normal paraffinic hydrocarbon manufactured by Chuo Kasei Co., Ltd.) were added. Then, a valve part with a stem having an orifice diameter of 0.25 mm, a housing having a main orifice diameter of 0.33 mm and no vapor tap was attached to the aerosol container. The aerosol container was filled with 40 parts of a propellant (liquefied petroleum gas) via the valve part. A mechanical break-up actuator with a spray outlet having an orifice diameter of 0.30 mm was attached to the aerosol container to obtain an aerosol containing 100 parts of the aerosol composition for controlling an insect pest (hereinafter referred to as “present aerosol D”).

### Comparative Preparation Example 1

Into an aerosol container, 4.5 parts of transfluthrin and 55.5 parts of Neo-chiozol (normal paraffinic hydrocarbon manufactured by Chuo Kasei Co., Ltd.) were added. Then, a valve part with a stem having an orifice diameter of 0.33 mm, a housing having a main orifice diameter of 2.03 mm and a vapor tap having an orifice diameter of 0.33 mm was attached to the aerosol container. The aerosol container was filled with 40 parts of propellant (liquefied petroleum gas) via the valve part. An actuator with a spray outlet having an orifice diameter of 0.41 mm was attached to the aerosol container to obtain an aerosol containing 100 parts of the aerosol composition for controlling an insect pest (hereinafter referred to as “reference aerosol A”).

### Comparative Preparation Example 2

Into an aerosol container, 4.5 parts of transfluthrin, and 55.5 parts of Neo-chiozol (normal paraffinic hydrocarbon manufactured by Chuo Kasei Co., Ltd.) were added. Then, a valve part with two stems having an orifice diameter of 0.51 mm, a housing having a main orifice diameter of 2.03 mm and a vapor tap having an orifice diameter of 0.51 mm was attached to the aerosol container. The aerosol container was filled with 40 parts of a propellant (liquefied petroleum gas) via the valve part. An actuator with a spray outlet having an orifice diameter of 0.76 mm was attached to the aerosol container to obtain an aerosol containing 100 parts of the aerosol composition for controlling an insect pest (hereinafter referred to as “reference aerosol B”).

### Comparative Preparation Example 3

Into an aerosol container, 0.2 parts of tetramethrin and 59.8 parts of Neo-chiozol (normal paraffinic hydrocarbon manufactured by Chuo Kasei Co., Ltd.) were added. Then, a valve part with a stem having an orifice diameter of 0.33 mm, a housing having a main orifice diameter of 2.03 mm and a vapor tap having an orifice diameter of 0.33 mm was attached to the aerosol container. The aerosol container was filled with 40 parts of a propellant (liquefied petroleum gas) via the valve part. An actuator with a spray outlet having an orifice diameter of 0.41 mm was attached to the aerosol container to obtain an aerosol containing 100 parts of the aerosol composition for controlling an insect pest (hereinafter referred to as “reference aerosol C”).

### Comparative Preparation Example 4

Into an aerosol container, 0.05 parts of prallethrin and 59.95 parts of Neo-chiozol. (normal paraffinic hydrocarbon manufactured by Chuo Kasei Co., Ltd.) were added. Then, a valve part with a stem having an orifice diameter of 0.33 mm, a housing having a main orifice diameter of 2.03 mm and a vapor tap having an orifice diameter of 0.33 mm was attached to the aerosol container. The aerosol container was filled with 40 parts of a propellant (liquefied petroleum gas) via the valve part. An actuator with a spray outlet having an orifice diameter of 0.41 mm was attached to the aerosol container to obtain an aerosol containing 100 parts of the aerosol composition for controlling an insect pest (hereinafter referred to as “reference aerosol D”).

The aerosols obtained in the preparation examples above were tested as to the spray arrival distance and the spraying amount per second under the conditions described below.

### Measurement of Spraying Amount and Spray Arrival Distance

The spray arrival distance (cm) and the spraying amount (g) per second of the present aerosols A-D, and the reference aerosols A-D were measured as described below.

The aerosol was put at the corner of a rectangular parallelepiped test chamber with the dimensions of 3.0 m×4.0 m×2.3 m (28 m³) at the height of 85 cm. The aerosol was sprayed for a second in the diagonal direction of the test chamber. Then, the distance was measured from the spraying point to the point where the white surface of the oil-sensitive paper: waxsheet (WA 45/3 SW Code 6320, from Gluthy-Renker) placed in the spray path was fully or partly changed into black. The waxsheet was also put 85 cm high above the chamber floor. The longest distance from the spraying point to the point where the color change of the wax sheet was detected was regarded as the spray arrival distance (cm).

Further, the spraying amount (g) per second was calculated from the weight change (reduction) of the aerosol after spraying for a certain time.

The measurement results and the aerosol characteristic values calculated from the formula (I) below are shown in the following Table.

TABLE 1

| | Spraying | Spray Arrival | Aerosol |
|---|---|---|---|
| | Amount (g) | Distance | Characteristic |
| | per second | (cm) | Value |
| Present Aerosol A | 0.32 | 95 | 7 |
| Present Aerosol B | 0.31 | 100 | 16 |
| Present Aerosol C | 0.33 | 95 | 7 |
| Present Aerosol D | 0.33 | 100 | 15 |
| Reference Aerosol A | 0.96 | 140 | 30 |
| Reference Aerosol B | 2.09 | 180 | 84 |
| Reference Aerosol C | 0.98 | 140 | 686 |
| Reference Aerosol D | 0.97 | 150 | 2910 |

Aerosol characteristic value=Spray arrival distance (cm)×Spraying amount (g) per second/Weight concentration (%) of Pyrethroid compound. Formula (I)

### Test Example 1

Into a test container with the inner wall spread with butter (having a diameter of 9 cm and a height of 7.5 cm and covered with wire net having 16 mesh), 6 individuals of Periplaneta americana were released. The container was put into a draft at an angle of 45° from the floor of the draft. The test aerosol was sprayed toward the upper surface of the container from 15 cm above the upper surface. The spraying amount of the test aerosol was set such that the insecticidal ingredient was sprayed in an amount of about 90 mg. The number of knocked down insects were counted 90 seconds after spraying (each test was repeated twice).

The results are shown in the following table.

TABLE 2

| | Ratio (%) of Knock |
|---|---|
| | Down after 90 sec. |
| Present Aerosol A | 100 |
| Present Aerosol B | 92 |
| Reference Aerosol A | 17 |
| Reference Aerosol B | 33 |

### Test Example 2

Into a test container with the inner wall spread with butter (having a diameter of 9 cm and a height of 7.5 cm and covered with wire net having 16 mesh), 10 individuals of Blattella germanica were released. The container was put into a draft at an angle of 45° from the floor of the draft. The test aerosol was sprayed toward the upper surface of the container from 15 cm above the upper surface. The spraying amount of the test aerosol was set such that the insecticidal ingredient was sprayed in an amount of about 10 mg. The number of knocked down insects were counted 10 seconds after spraying.

The results are shown in the following table.

TABLE 3

| | Ratio (%) of Knock |
|---|---|
| | Down after 10 sec. |
| Present Aerosol C | 70 |
| Present Aerosol D | 80 |
| Reference Aerosol C | 30 |
| Reference Aerosol D | 30 |

### INDUSTRIAL AVAILABILITY OF INVENTION

The present aerosol has an excellent controlling effect on an insect pest, and is especially suitable for indoor use.

1. A direct hit type aerosol for controlling an insect pest, comprising at least one pyrethroid compound, at least one organic solvent and at least one propellant, wherein the aerosol characteristic value calculated from the following formula is 0.5 to 25,
Formula) Aerosol characteristic value=Spray arrival distance (cm)×Spraying amount (g) per second/Weight concentration (%) of Pyrethroid compound.

2. The aerosol according to claim 1, wherein the pyrethroid compound is a compound represented by the formula (I): 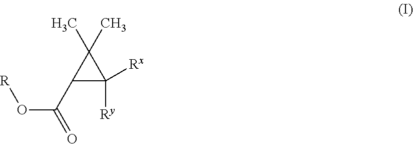
wherein
both R^{x} and R^{y} represent a methyl group; or
R^{x} represents a hydrogen atom and R^{y} represents a group of the following formula: 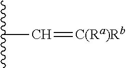
wherein
R^{a} represents a hydrogen atom, a halogen atom or a methyl group and R^{b} represents a halogen atom, a methyl group, a trifluoromethyl group or a cyano group; and
R represents a group selected from the following groups: 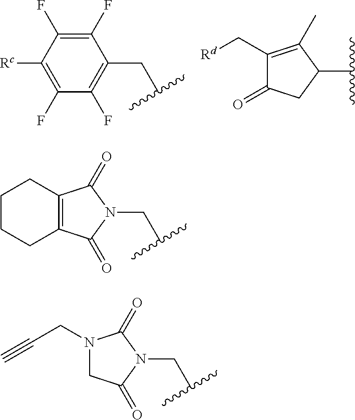
wherein
R^{c} represents a hydrogen atom, a methyl group, a propargyl group or a methoxymethyl group and R^{d} represents a vinyl group or an ethynyl group.

3. The aerosol according to claim 1, wherein the pyrethroid compound is at least one compound selected from the group consisting of imiprothrin, tetramethrin, prallethrin, transfluthrin, metofluthrin, dimefluthrin, 2,3,5,6-tetrafluoro-4-(methoxymethyl)benzyl 2,2-dimethyl-3-[(1z)-3,3,3-trifluoro-1-propenyl]cyclopropanecarboxylate, 2,3,5,6-tetrafluoro-4-methylbenzyl 2,2-dimethyl-3-(1-propenyl)cyclopropanecarboxylate, 2,3,5,6-tetrafluoro-4-(methoxymethyl)benzyl 2,2,3,3-tetramethylcyclopropanecarboxylate and 2,3,5,6-tetrafluoro-4-(methoxymethyl)benzyl 2,2-dimethyl-3-(2,2-dichlorovinyl)cyclopropanecarboxylate.

4. The aerosol according to claim 1, wherein the weight concentration of the pyrethroid compound is 2.0 to 10 wt %.

5. The aerosol according to claim 1, wherein the spraying amount per second is 0.1 to 0.4 g.

6. The aerosol according to claim 1, wherein the spray arrival distance is 70 to 120 cm.

7. The aerosol according to claim 1, wherein the organic solvent contains a saturated hydrocarbon solvent in an amount of 50 wt % or more.

8. The aerosol according to claim 1, wherein the capacity of the aerosol can is 200 ml or less.

9. A method for controlling an insect pest, which comprises spraying the aerosol according to claim 1 to an insect pest flying in the indoor space or crawling on the floor or wall indoors.

10. The aerosol according to claim 2, wherein the weight concentration of the pyrethroid compound is 2.0 to 10 wt %.

11. The aerosol according to claim 3, wherein the weight concentration of the pyrethroid compound is 2.0 to 10 wt %.

12. The aerosol according to claim 2, wherein the spraying amount per second is 0.1 to 0.4 g.

13. The aerosol according to claim 3, wherein the spraying amount per second is 0.1 to 0.4 g.

14. The aerosol according to claim 4, wherein the spraying amount per second is 0.1 to 0.4 g.

15. The aerosol according to claim 2, wherein the spray arrival distance is 70 to 120 cm.

16. The aerosol according to claim 3, wherein the spray arrival distance is 70 to 120 cm.

17. The aerosol according to claim 4, wherein the spray arrival distance is 70 to 120 cm.

18. The aerosol according to claim 5, wherein the spray arrival distance is 70 to 120 cm.

19. The aerosol according to claim 2, wherein the organic solvent contains a saturated hydrocarbon solvent in an amount of 50 wt % or more.

20. The aerosol according to claim 3, wherein the organic solvent contains a saturated hydrocarbon solvent in an amount of 50 wt % or more.
